(19) United States
(12) Patent Application Publication
(10) Pub. No.: US 2004/0153373 A1
(43) Pub. Date: Aug. 5, 2004

(54) Method and system for pushing services to mobile devices in smart environments using a context-aware recommender

(75) Inventors: Yu Song, Milpitas, CA (US); Hao-Hua Chu, Mountain View, CA (US); Masaji Katagiri, Los Altos, CA (US)

Correspondence Address: Brinks Hofer Gilson & Lione, NBC Tower, Suite 3600, P.O. Box 10395, Chicago, IL, 60610, US

(73) Assignee: DoCoMo Communications Laboratories USA, Inc.

(21) Appl. No.: 10/355,742

(22) Filed: Jan. 31, 2003

(51) Int. Cl. G06F 17/60

(52) U.S. Cl. 705/26

(57) ABSTRACT

A context-aware service recommender system receives current user context and recommends a list of browser-based services to a user on a mobile devices. A user's mobile device receives context events from smart environments in which the mobile device is operating. Data about the context events is relayed to a service recommendation server. The server develops recommendations based on the context and other factors, and relays information about the recommended services to the mobile device. As each recommended service is selected or ignored by the user of the mobile device, the device sends implicit feedback with this information to the service recommendation server for use in subsequent recommendations.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present invention relates generally to data communication and data processing systems. More specifically, the present invention relates to a method and system for pushing services to mobile devices in smart environments using a context-aware recommender.

Recently, there has been a growing interest in building smart environments and pervasive computing systems that can seamlessly integrate users' everyday lives with artifacts of computing and communication capabilities in the surrounding environment. In smart environments, ubiquitous computing resources assist with many tasks. In order to provide such seamless user experience, the smart environment must be able to determine the current user context includes user location, orientation, time of day, etc. The smart environment must further decide on appropriate actions. In existing smart environments, these actions are supported by context-aware services or applications that are built specifically for each environment. A smart environment system provides contextual events to the interested context-aware services that may handle these events.

Because context-aware services are built specifically for each smart environment, the number of available services is limited by each environment. However, there is a much wider selection of global, environment-independent services and applications that exist and are accessible on the Internet. Global services are typically browser-based services that are accessible from most mobile devices equipped with web browsers for World Wide Web access. Users should be able to use these global services in smart environments as easily as local, context-aware services. At the same time, browser-based service providers should be able to deploy such global services that can be used in any smart environments without any environment-dependent customizations.

Because these services are not designed for any particular smart environment, they lack any notion of user context in an environment, and conversely, the smart environment has no notion of the applicability or usefulness of such a service. In particular, context events provided by a smart environment are not handled by global services. For example, in a smart grocery store equipped with sensors, there is no way for a user to incorporate a web-based consumer report service into the activity of shopping. The smart environment does not know to invoke a consumer report search when it senses that a user has picked up an item, and the consumer report service has no other way of activating itself.

The ability for services to be found and invoked effortlessly—for services to be pushed to users, rather than for users to manually search for and invoke them—is crucial in context-aware environments, because use of computing services in everyday tasks must require minimal effort from users. It would be immensely inconvenient for users to search for services while holding a basket of groceries, or while standing in line at the checkout counter, on a mobile device with a small display, over a slow wireless network. Therefore, a push model rather than a pull model is essential in getting services to mobile users.

FIG. 1 illustrates a prior art recommender system 100 in an electronic commerce web site. The system 100 includes a web server 102 accessible by user client computers 104 over a network such as the Internet 106. The system 100 further includes a database 108 and a recommender. The web server 102 accesses the database 108 which stores information about user interests and browsing behavior. The recommender responds to this stored information to recommend other products that may be of interest to a user of a client computer 104.

In these systems, users browse the electronic commerce web site for products or other items of interest. Based on users' interests and browsing behaviors, the web server 102 consults the item recommender 110 that can recommend a list of items that may be of interest to users. The web server 102 then returns the list to the user.

### BRIEF SUMMARY

By way of introduction only, the presently disclosed embodiments provide a context-aware service recommender that can infer triggering conditions for any services in smart environments, and push personalized recommendations of relevant services to users based on current user context. Current user context in the context-aware recommender system is distinguished from user history (e.g., purchase or browsing history) in traditional recommender systems. Both the context-aware recommender system and traditional recommender systems use user history to populate the dataset. In the present context-aware recommender system, context is defined to mean a user's interaction or activities with the smart environment. User context is any information that is used to describe the situation of a user. Sending context to service a recommendation service can be achieved in many ways. One embodiment can be encapsulate context into one or more context events, and sending the context events to the server.

The present embodiments further include a context-aware service recommender system that receives current user context and recommends a list of browser-based services to a user on a mobile devices. The system includes a smart environment that provides current context and a network-accessible recommender server. The recommender server receives current user context from a remote recommendation agent, runs an algorithm to generate a list of recommended services, sends the list of recommended service back to the remote recommendation agent, receives feedback from the remote recommendation agent, and update a service relevance data set. The system further includes a service recommender agent installable on a mobile device. The service recommender agent is configured to relay current user context to the service recommender server, receive recommended services from the service recommendation server, display recommended services, monitor user's selection of services, and transmit user's service selection on services to the recommender server.

The present embodiment further includes a service relevance rating dataset that is a three dimensional matrix of <user, context, service>, where each entry in the matrix contains a rating that represents the level of relevance of a service to a user in a context.

The present embodiments further include a method of browser-based service recommendation that uses context-mapping. The method includes calculating context similarity, determining user or service neighborhood selections from multiple contexts, and generating a list of recommended services based on user or service neighborhoods, active user, and current user context.

The foregoing summary has been provided only by way of introduction. Nothing in this section should be taken as a limitation on the following claims, which define the scope of the invention.

### BRIEF DESCRIPTION OF THE DRAWINGS

FIG. 1 is a block diagram illustrating a prior art recommender system;

FIG. 2 is a block diagram of a context-aware service recommender;

FIG. 3 is a flow diagram illustrating one embodiment of operation of the context-aware service recommender of FIG. 2;

FIG. 4 is a flow diagram illustrating a method for creating implicit feedback and updating a data set; and

FIG. 5 is a flow diagram illustrating context-based collaborative filtering.

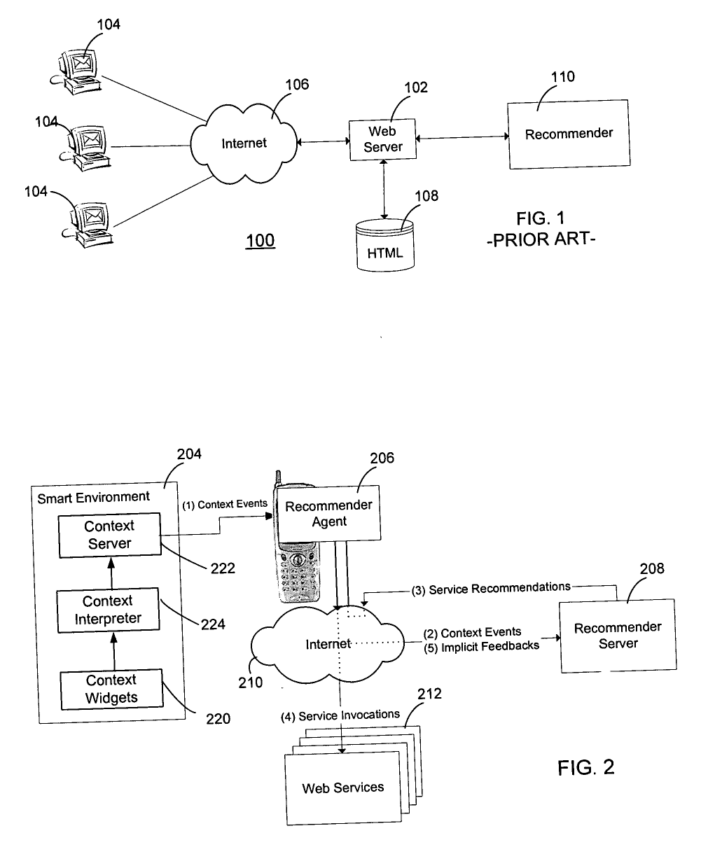

### DETAILED DESCRIPTION OF THE PRESENTLY PREFERRED EMBODIMENTS

The following scenario further illustrates the motivation for a context-aware service recommender:

A user needs to go grocery shopping. Before going to the store, she prepares a shopping list using a shopping list service. She then goes to a supermarket that is a smart environment in which location detection sensors are installed throughout the store, and all of the price tags on the products contain embedded sensors. She brings a mobile device with her, to access the shopping list and other services, and to use the service recommendation agent for service recommendation.

The store first detects when the user enters. This triggers the recommendation agent to notice that the shopping list service is relevant to the environment, and that it can be used together with the store's local map service to help the user find the locations of her needed items.

The user follows the map on her mobile device to find a bottle of milk on her shopping list, and picks it up. The embedded sensor in the price tag on the bottle then triggers the user's agent to recommend two services: a web consumer report service and a local coupon service. She selects the consumer report service first, and the agent automatically extracts the barcode on the bottle and feeds it into the consumer report service. A consumer report recommending the brand of milk is then displayed on her mobile device. She then selects the coupon service to see if there is a store coupon on this or any other milk. The coupon service does report a store discount on this item, so she puts the milk into her cart and continues shopping.

After completing her shopping, the user goes to an automatic checkout counter. A scanner at the checkout counter scans items in her shopping cart and computes the total price. This triggers the recommendation agent to recommend the store coupon service and the user's credit card service. The user uses the coupon service to receive the store discounts, and her credit card service to pay the bill.

Relative to prior art systems, there is an important difference provided by the presently-disclosed embodiments. User context is an additional dimension to the matrix that the recommender algorithms must analyze. The dimension of context is defined to be folded <environment, event> pairs. That is, every context event, such as entering a store, arriving at a checkout counter, picking up a product, in every smart environment is considered a point of context. Therefore, the matrix to be considered can be visualized as a three-dimensional <user, context, service> matrix. On a first axis are users; on the second axis are services; and on the third axis are contexts.

This additional dimension allows exploration of similar contexts, in addition to similar users and services, to determine predictions of relevant services. For example, if a user is in the context cₐ, a service s is commonly invoked in context c_{b}, and contexts cₐ and c_{b} are closely correlated, and then the service s could be recommended to the user. The basic challenge that must be addressed is to provide a class of new algorithms with the ability to consider this additional dimension and its semantics.

In one embodiment, the system relies on a context-based infrastructure for smart environments. Context-based infrastructure describes a new abstraction that separates the acquisition and interpretation of context data, which is done and supported by the infrastructure, from the application of context data by context-aware applications. The benefit is that the context information can be easily re-used by different context-aware applications, so each context-aware application does not have to repeat the same work of acquiring and interpreting context data. The context-based infrastructure typically contains the following components—context widgets 220 that acquire the context data from sensor network, a context server 222 that aggregates context data from different sensor sources, and context interpreters 224 that interpret context data into application-level context events that can be used by applications. The context server 222 in the smart environment corresponds to the aggregated modules of context widgets/server/interpreters in, and the service recommender is a context-aware application that subscribes to the application-level context events from the context server 222.

FIG. 2 is a block diagram of a context-aware service recommender system 200. The system 200 includes one or more smart environments 202, one or more mobile device 204 operating a recommender agent 206 and a recommender server 208 accessible over a network such as the internet 210, which also provides access to browser-based services 212.

The smart environment 202 generally includes a plurality of sensors and a context server. The sensors can detect user context and transmit low-level context data to the context server. The sensors detect the presence of a mobile device such as the mobile device 204 and report the context data to the context server. This detection may be by radio contact, such as over a Bluetooth or IEEE 802.11-type wireless connection, or by optical connection such as IrDA, or by any other suitable method. The sensor detects identification information for the mobile device and records other information as well, such as the date, time and geographic location. Some sensors may also obtain other context information, such as by photographing the user of the mobile device and analyzing the photographs to determine the mood or state of mind of the user. Other objectively observable information, such as the items carried by the user, attire worn by the user, purchases carried in a shopping cart, and so forth, may also be gathered by the smart environment sensors and passed to the context server of the smart environment.

In one embodiment, all transmission of context information between components in the architecture uses secure connections (e.g., SSL) for privacy protection. The context server in the smart environments translates sensor data into application-level context events. The context server sends the context events to a user's mobile device 204 (assumed Internet-capable). Context events contain, among other things, the user identity, the type of the event, and the smart environment identity (e.g., <“Jane”, “Pick up milk,”, “Supermarket A”>). Any suitable format and protocol for communication of the context events may be used. The format may be proprietary so that only paying subscribers may receive the context events at the mobile device 204.

The mobile device 204 may be any electronic device which includes telecommunication capability. Two examples are a cellular or wireless telephone, and a personal digital assistant (PDA). The mobile device 204 provides mobile communication, meaning that the device 204 may establish communication with a variety of base stations or radio fixed parts as the mobile device 204 is transported by the user. The mobile device 204 may communicate according to a variety of different radio air interfaces. For example, radio communication with radio-based Internet-linked devices may be according to third generation voice or data radio standards, which provide relatively long range communication and hand off capability at speeds up-to 100 km/h, while communication with the smart environment may be by means of shorter range radio technology, such as Bluetooth or IEEE standard 802.11.

The mobile device 204 preferably includes one or more radio interfaces, a processor and a user interface. The radio interfaces provide the necessary radio communication in the system 200. The radio interfaces in general include a receiver circuit and a transmitter circuit and may include such devices as oscillators, mixers, filters, modulators and demodulators. The processor provides control and other operation of the mobile device 204. The processor generally operates in response to data and instructions stored in memory of the mobile device 204. The user interface provides user control of the functionality of the mobile device 204. The user interface includes devices required for such control. Examples include a microphone, speaker, keypad and display.

One example of a program stored in memory and operating on the processor of the mobile device 204 is the service recommender agent 206. Context events received from the smart environment are handled by the service recommender agent 206 running on the user's mobile device. The agent 206 is a thin client for the service recommender operating on the service recommender server 208.

The service recommender is a browser-based service, accessible from the Internet 210. The recommender agent 206 relays the context events to the service recommender server 208 for processing by the service recommender. The service recommender may be embodied as computer program code such as an application program running on the service recommender server 208. The purpose of the service recommender is to recommend other browser-based services, such as browser-based services 212, that may be relevant to the user's context. The service recommender contains a service relevance rating dataset, referred to herein as a dataset or matrix, which is the matrix of relevance ratings for services used by users in different contexts.

Once a context event is sent to the service recommender, the service recommender uses the context event as input to an algorithm that searches the dataset for services relevant to that context event. The service recommender returns a list of recommended services. In one embodiment, the list is composed of a combination of services that a user has used, and determined to be relevant in that context before, and services that have not been used in that context, but which may be relevant based on information from similar contexts, users, or services. The list is communicated over the Internet 210 or other network to the mobile device 204. The list appears to the user of the mobile device 204 as a list of N top-rated services, displayed in the agent on the mobile device. For example, text or graphical information may be displayed on the user interface of the mobile device. The visual information may be supplemented with other information such as audio information like music. A well-known theme song associated with a service may be played as the recommended service is displayed. The user may select any number of recommended services from this list of services and invoke them. The recommender agent monitors which recommended services are invoked, and which are not, and relays that information as implicit feedback to the service recommender. The service recommender uses this feedback to adjust its ratings in the dataset.

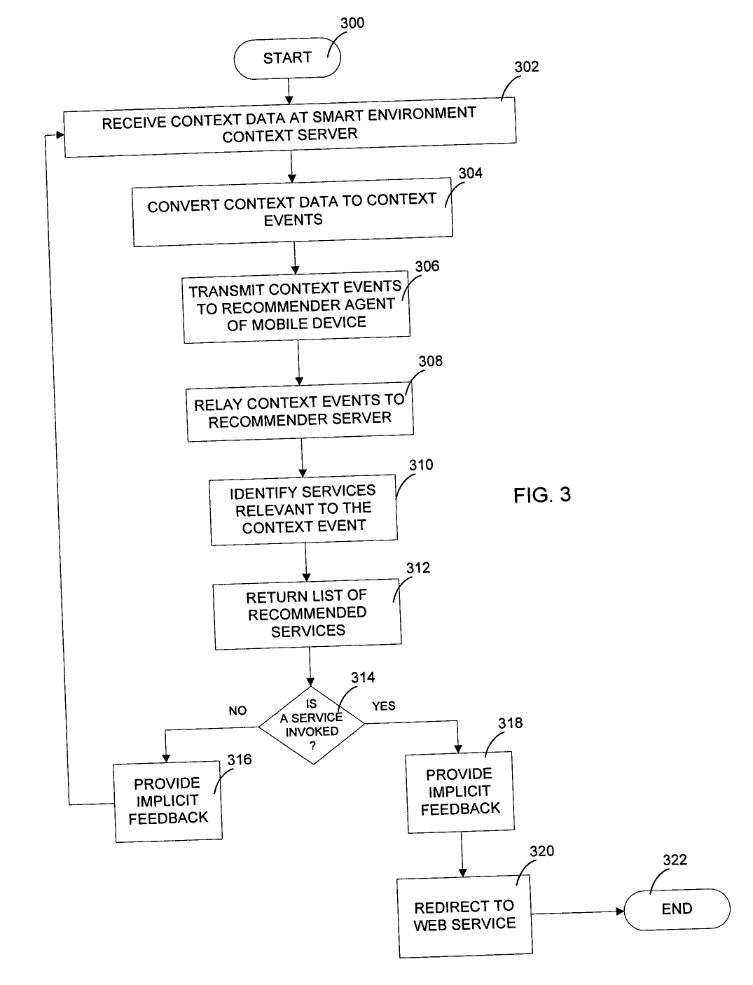

FIG. 3 is a flow diagram illustrating one embodiment of a method for operating the system 200 of FIG. 2. The method begins at block 300. At block 302, the context server of the smart environment receives context data from the sensors of the smart environment. The context data may have any suitable format, and may have a variety of formats depending on the nature of the server. The context server processes all the context data and produces one or more context events, block 306.

The context events are then communicated to the recommender agent of the mobile device, block 308. The mobile device relays the context events to the service recommender server, block 310. This relay may be a simple repeating operation. Alternatively, the context event received from the smart environment may be processed by the recommender agent before transmission of a new context event to the recommender server. For example, if two different radio air interfaces are used by the mobile device, the data received over a first air interface from the smart environment may be re-formatted as to packet size and content before transmitting new packets to the recommender server over a second air interface.

At block 310, the recommender server identifies services appropriate for the user of the mobile device, based on the context event. More information about this process will be provided below. At block 312, the list of recommended services is returned to the mobile device for display on the mobile device.

At block 314, the recommender agent determines if a service is invoked. In one embodiment, the recommender agent determines for each recommended service whether the service is invoked. If the service is not invoked, at block 316, implicit feedback is provided by the recommender agent to the recommender server. Control then returns to block 302 as the smart environment continues collecting context data. If, at block 314, a service was invoked by the user of the mobile device, at block 318, the recommender agent provides implicit feedback to the recommender server. At block 320, the web browser or other device of the mobile device is then redirected to the invoked service, for example, by sending a page request to the uniform resource locator (URL) associated with the service so that the user of the mobile device may begin using the invoked service. The method then ends at block 322.

It will be understood that the operations illustrated in FIG. 3 to be performed by the system may be performed by any suitable component of the system. Thus, the operation of transmitting context events from the context server to the recommender server could be done by the smart environment itself, rather than relaying the context events through the mobile device. The illustrated operations may be distributed throughout the system in any suitable manner.

As mentioned before, the dataset used by the service recommender is configured in one embodiment as a three-dimensional <user, context, service> matrix. Each point in this matrix is a triple containing a numeric rating, for example, between 0, for the least relevant services, and 1, for the most relevant services, the number of invocations of a service, and the number of times the service was recommended. Ratings are denoted as R, the number of invocations of a service is denoted as Nₚₒₛᵢₜᵢᵥₑ, and the total number of times a service is recommended is denoted as Nₜₒₜₐₗ. The support of a rating is derived from Nₜₒₜₐₗ, meaning how much confidence there is in a rating. These variables will be used herein to determine how to compute predictions from ratings, and how ratings change over time. Points in the matrix may also be empty (i.e. contain no data). An empty data point indicates that a given user has not used a given service in a given context.

Unlike existing recommender systems that ask users for explicit ratings on items, the service recommender in accordance with one embodiment infers ratings from users' implicit feedback, which is determined by monitoring whether or not recommended services are used. Implicit feedback is one key element of the system's design. If explicit feedback on the actual relevance of recommended services was required from users, the service recommender would be too intrusive and cumbersome for use in daily tasks. Therefore, the quality of recommendations and the relevance of services are evaluated using implicit feedback. There are two types of implicit feedback in the disclosed system, positive and negative, and they are used as shown in the table below.

| | Recommended Services | Non-recommended Services |
|---|---|---|
| Selected Services | Positive | Positive |
| Ignored Services | Negative | (none) |

Services that are recommended and selected by the user are given positive feedback, indicating that the recommendation was correct, and the service is relevant to the user's context. Services that are recommended but ignored by the user are given negative feedback, with the reasoning that for a sufficiently small list of recommended services the user has had the chance to review and ignore each of them. Services that are not part of the top list of recommendations, but are explicitly searched for and used by the user are given positive feedback. Lastly, no implicit feedback can be inferred from services that are neither recommended nor used, because the user has not had the opportunity to review them.

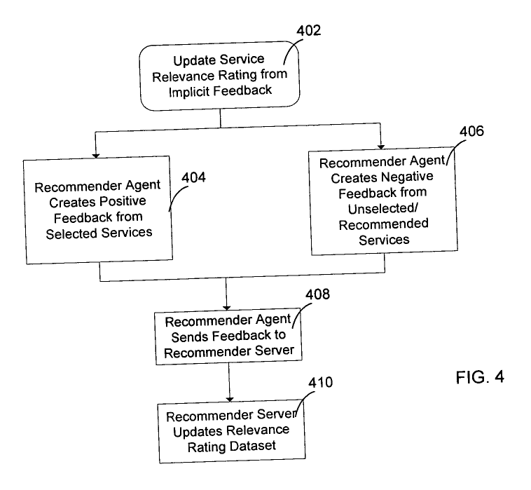

One procedure for creating implicit feedback and updating the relevance rating dataset is shown in FIG. 4. At block 402, the recommender server updates its service relevance rating based on implicit feedback received from a user's mobile device. The implicit feedback is based on the selection of a recommended service, as described above. At block 404, if a user selected a recommended service, the recommender agent creates positive feedback for that service. Conversely, at block 406, if the user did not select a recommended service, the recommender agent creates negative feedback for that service. After creation of the implicit feedback, whether positive or negative, the feedback is sent to the recommender server, block 408. In response to the received feedback, the recommender server updates its relevance rating dataset for use with a subsequently received context event.

Implicit feedback is created by the recommendation agent for every context event that triggers the recommendation of a list of services. The list of services is partitioned into those receiving positive feedback and those receiving negative feedback.

In one embodiment, the data structure for implicit feedbacks has the form:

```
struct Feedback {
  User u;
  Context c;
  list<Service> positive;
  list<Service> negative;
}
```

This implicit feedback is used by the recommender to compute new ratings and update existing ratings in the dataset, to reflect user's behavior on services in a context. There are many methods to calculate a rating. One simple way is to compute the rating as the ratio of the number of positive feedbacks for a service to the total number of feedbacks:

$$R = \frac{{N}_{positive}}{{N}_{total}} \qquad ( 1 )$$

However, this simple method does not take into account that a user may change behavior over a period of time. For example, a user may not select a service s until the twentieth time the service is recommended. For the rating of that service to increase from 0 to 0.5, the user must invoke it 20 times. The recommender can better adjust to users by putting more weight on users' recent behavior if they select the service, and less weight on old behavior. Conversely, if the user has consistently used the service until the twentieth occurrence of its triggering context, at which time the service is not selected, it cannot be determined that this represents a true loss of interest in the service. Therefore, the rating of the service should not decrease rapidly. The recommender can better adjust to users by decreasing the rating slowly. A better-tuned rating adjustment formula might therefore take this form:

$$R = \{ \begin{matrix}α {R}_{prev} + ( 1 - α ) & if service is selected \\ {R}_{prev} - β & if service is ignored , and {R}_{prev} > β \\ 0 & if service is ignored , and {R}_{prev} \leq β\end{matrix} \qquad ( 2 )$$

In the first part of the formula, ratings are increased exponentially by weighting the old rating with a factor of α(0<α<<1), and adding (1−α) if the service is invoked. In the second and the third parts of the formula, the ratings are decreased linearly by subtracting a constant β(0<β<<1) if the service is not selected. If the rating reaches 0, then it remains at that level.

In one embodiment, the context-aware service recommender system can operate in either manual mode or streaming mode chosen by a user. In streaming mode, a user of a mobile device activates the recommender once, and service recommendations are continuously generated and updated whenever there is a change in current user context. In manual mode, a user activates the recommender each time a recommendation is needed, for example by pressing a “recommend” button of the user interface of the mobile device or by some other actuation. The two modes handle context events streaming from the context server.

The two modes may be alternately selected according to different user preferences. If a user is interested to see what services are relevant to his changing user context, the streaming mode is more appropriate. However, if the user is familiar with the smart environment and is only interested in recommendations in certain contexts, the manual mode may be more appropriate.

When a user selects a browser-based service from the list of recommended services, the recommendation agent invokes that service. For example, when the user in the exemplary scenario picks up the bottle of milk, the recommender service displays a list that includes the consumer report service. When the user selects the service in the list, the agent directs web browser on her mobile device to the consumer report website. Preferably, this is done with a single click or other user interface actuation.

Like any recommender systems, user privacy must be maintained for at least some users. There are three entities involved in the exemplary recommender system 200 of FIG. 2. These include one or more smart environment operators, such as the operator of the smart environment 202, one or more service recommender providers, such as the operator of the service recommender server 208, and users such as the user of the mobile device 204.

Two pieces of information can be subject to privacy protection. First, context events are generated by the smart environment and sent to the service recommender indirectly through the user's mobile device. Second, implicit feedback is sent from the user's mobile device to the service recommender. Since both context event data and feedback data go through the user's mobile device in this embodiment, the user can control whether to share this data with the service recommender. The recommender agent running on the mobile device can use a simple permission-based scheme. The user can choose not to share any implicit feedbacks with the service recommender. However, given the lack of feedbacks from the user, the service recommender can only provide non-personalized popularity-based service recommendation to the active user. The user can also choose not to share any contexts from some specified smart environment with the service recommender. However, the lack of context disables service recommender because the context is a necessary input for the service recommender.

The service recommender server 208 of FIG. 2 is responsible for generating recommendations of services for the user of the mobile device 204. In the preferred embodiment, a new class of collaborative filtering algorithms is used in the context-aware service recommender to generate predictions and recommendations. This algorithm may be termed context-based collaborative filtering algorithms. They can provide personalized service recommendations. The inputs to the algorithms are identification information for the active user and his or her current context. Based on the inputs, the algorithms predict ratings for the active user in the current context. The algorithms then combine the existing ratings, if any, and the predicted ratings to derive a final prediction. The algorithms generate the top-N service recommendation according to final predictions. N may be any suitable integer number, such as 5.

Context-based collaborative filtering algorithms improve on algorithms in traditional recommender systems by leveraging the additional context dimension in a number of ways. Context-based algorithms can use multiple, similar contexts to select better, higher quality user or service neighborhoods, and use existing ratings from these neighborhoods to predict ratings in the current context for the active user. Context-based algorithms also apply additional weightings to existing ratings in the dataset from multiple contexts to compute the predictions. These additional weightings may be generalized to any prediction schemes that derive ratings from implicit feedback and draw predictions from ratings in multiple contexts.

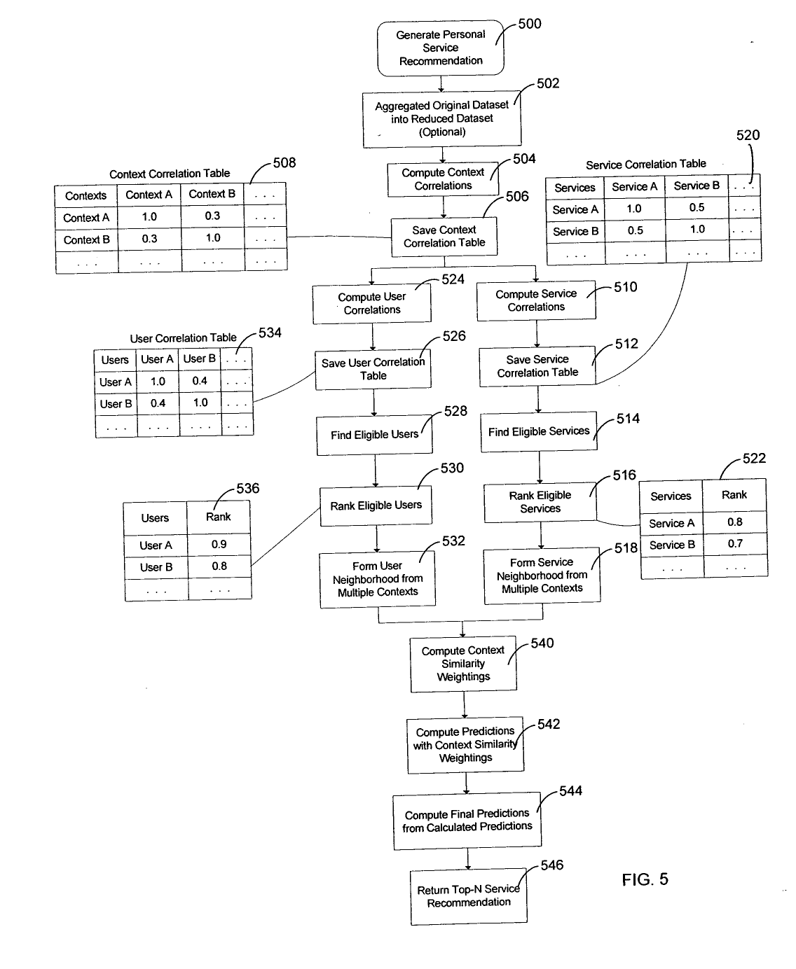

FIG. 5 illustrates context-based collaborative filtering algorithms. The context-based collaborative filtering algorithms are divided into the following three steps: (1) computing similarities between contexts, (2) forming user or service neighborhoods from multiple contexts, and (3) predicting ratings. The details of each step are explained below.

The method for generating personal service recommendations for a user operation a mobile device begins at block 500. At block 502, in an optional operation, the original dataset is aggregated into a reduced dataset. The original dataset includes all context events received for the user, plus context events for other users and other contexts. To make the dataset more manageable, the dataset may be aggregated and reduced in size.

At block 504, context correlations are computed and formed into a context correlation table. At block 506, the context correlation is saved in a suitable storage device. An exemplary format of a context correlation table 508 is shown in FIG. 5. The context correlations are a measure of the similarity between two contexts. As shown in the exemplary context correlation table 508, the correlation between a context and itself is equal to 1.0. Two completely dissimilar contexts would have a correlation of 0.

Context-based algorithms compute context similarities such that the algorithms can draw predictions from multiple, similar contexts. For example, to compute similarity between two contexts, cᵢ and cⱼ, a simple method would be to apply Pearson correlation between two slices of the matrix corresponding to these two contexts. Since the original Pearson correlation works on two vectors rather than two matrices, each matrix must be transformed by folding columns or rows in the matrix slice into a single, long vector.

One limitation of this simple method is that the original dataset may be very sparse, so there may be very few co-rated entries between two context matrix slices. Co-rated points in two sets are defined as those corresponding points in each set that are non-empty. For example, in the sets {a, -, c, d} and {A, B, -, D}, the co-rated entries are the first and fourth. Since the accuracy of the Pearson correlation depends on the number of co-rated entries between two context matrix slices, a sparse matrix results in inaccurate correlation values. To solve this problem, two methods are introduced to reduce data sparsity in the original matrix. The first method is service categorization. The second method is user aggregation.

In service categorization, individual browser-based services are grouped into categories, and each service category acquires an aggregate rating computed as the average of ratings of services in the category. The result is that the size of the service dimension is significantly reduced. The dataset therefore becomes less sparse, and the number of co-rated entries between contexts increases such that Pearson correlation may be used successfully.

There are many possible ways to classify services into their service categories. For example, service providers can categorize their browser-based services according to a common classification system, such as North American Industry Classification System (NAICS). Alternatively, service providers can provide descriptions of their browser-based services, and well-known clustering algorithms (e.g., K-Means clustering algorithm) can be applied to classify services based on common occurrences of terms in the service descriptions. Once the dataset has been made denser, the context slices can then be folded into context vectors, and the Pearson correlation can be applied.

In FIG. 5, blocks 510, 512, 514, 516 and 518 illustrate selecting a service neighborhood. Blocks 524, 526, 528, 530 and 532 illustrate selecting a user neighborhood.

In user aggregation, all the users' ratings on a service in a given context are averaged into an aggregate rating. The intuition is that when calculating the similarity between two contexts, it is sufficient to use average users' ratings on services. The result is that the original <user, context, service> matrix is reduced in dimension to a <context, service> matrix. Again, the density of data in this matrix is greater, so we can directly apply Pearson correlation to find the context similarities.

These two methods of forming user neighborhoods and service neighborhoods are complementary to each other, meaning that they can be applied either together or separately. If one method does not sufficiently reduce the data sparsity in the original dataset, the other method may be applied to the partially-reduced dataset to further reduce it. Also note that this reduced dataset is only used to determine similarities between contexts and is not used in the final computation to predict missing ratings. This ensures that aggregation, which explicitly removes personal user preferences and/or service specifics from the dataset, does not have any negative effect on the final recommendation quality.

As noted, the final result of this step is to generate a context correlation table containing the calculated similarities between every context. The process of reducing the dataset through service categorization and/or user aggregation and then computing Pearson correlations between each context in the reduced dataset is computationally intensive, so it is done offline at regular intervals, such as once per day. This yields an acceptably accurate table because context events, smart environments, and the similarities between them are relatively static. They are very unlikely to change significantly between computation intervals.

The next step of the context-based collaborative filtering algorithm involves forming user or service neighborhoods from multiple contexts. Context-based collaborative filtering algorithms have two approaches to generate predictions for ratings on services. The first approach is to form a k-nearest user neighborhood based on ratings from multiple contexts. The second approach is to form a k-closest service neighborhood, again based on ratings from multiple contexts. Rating predictions are then derived from existing ratings in the user or service neighborhood. These two approaches are analogous to the user-based and item-based approaches in traditional recommender systems.

In comparison with traditional recommender systems, the context-based algorithms are able to select higher quality user or service neighborhoods by making use of existing ratings from multiple contexts. High quality means that neighbors have high similarities or correlations with the active user or service. However, this requires additional computation. The process of forming user or service neighborhoods in context-based collaborative filtering has three steps: creating a user or service correlation table, shown in FIG. 5, blocks 510, 512 and 524, 526; determining eligible users or services, blocks 514 and 528; and determining the closest neighbors, blocks 516 and 530.

The first step of creating a user or service correlation table can be accomplished by folding each two-dimensional user or service slice of the three-dimensional matrix into a user or service vector and applying Pearson correlation on the resultant vectors. This process is similar to how context correlation is computed described above. The result of this step is to generate a user or service correlation table, blocks 512, 526, that contains correlations between every pair of users or services in the dataset. If the dataset is too sparse, it is possible to aggregate contexts to increase the data density; however this may result in less-personalized recommendations. Like the context correlation table, the user or service correlation table is also computed offline because users and services are considered to be relatively static over time.

Because the collaborative-filtering recommendation formulas require data which directly pertains to the target service whose rating is being predicted, the second step is to determine which users or services are eligible to participate in the recommendation calculation, blocks 514, 528. Some rules are applied for making this determination. First, a user is eligible if it has a rating on the target service, in one or more similar contexts. Second, a service is eligible if it is rated by the active user in one or more similar contexts. If the user did not have a rating on the target service or if the service was not rated by the active user, that user or service would be ineligible to serve as a neighbor, meaning that it would not be useful in the final prediction calculation.

After ineligible users or services are eliminated, the final step is to find the k-nearest eligible neighbor users or services to the active user or service, blocks 516, 530. Two different methods to find k eligible user or service neighbors are proposed.

The first method is M-Closest-Contexts method. This method selects neighbors from the m-closest contexts to the current context, based on a lookup in the context correlation table. Eligibility of neighbors is determined by restricting similar contexts to these m-closest contexts. Neighbors are ranked according to their correlation with the active user or target service, determined by a lookup in the user or service correlation table.

The second method is a combined method. This method uses all contexts, and weighting the correlation between the user or service neighbor and the active user or target service, with a factor of the correlation between the neighbor's context and the current context.

These factors are determined by lookup in the user correlation table 534 or service correlation table 520 and the context correlation table 508, respectively. Eligibility in this method is determined from all contexts.

Once the neighbors are ranked, blocks 516, 530, the top k neighbors with highest rankings are selected to form the user or service neighborhood, block 518, 532.

The last step of the context-based collaborative filtering algorithms is to predict ratings for the active user in the current context. In FIG. 5, this is illustrated in blocks 540, 542, 544, 546. In one embodiment, the predicted rating is computed as a weighted average of existing ratings from similar users, services, or contexts.

One key element in prediction is to assign an appropriate weight, block 540, to each user in the k-closest user neighborhood, to each service in the k-closest service neighborhood, or to each context in the m-closest context neighborhood. In addition to weightings used in existing collaborative filtering, the context-based algorithms have several additional considerations.

Support Weighting (wₛᵤₚ) Since ratings are derived from cumulative, implicit feedbacks, we would like to place more support on ratings that are based on larger sample sizes than those that are based on smaller sample sizes. The support of a rating is a function of the number of feedbacks as discussed above. It is given by the following relation:

$${w}_{sup} = \{ \begin{matrix}\frac{{N}_{total}}{{N}_{threshold}} if {N}_{total} < {N}_{threshold} \\ 1\end{matrix} \qquad ( 3 )$$

In this formula, the threshold value N_{threshold} is determined through experimentation. If the total number of feedbacks in a context is less than the threshold value, the existing rating is adjusted by the support weighting.

Context Similarity Weighting (Wₛᵢₘ) User or service neighborhoods are selected from multiple contexts. When a prediction is computed on a service for the active user in the current context using ratings from user or service neighborhoods, varying context similarities must be accounted for between the current context and its m-closest context neighborhood from which ratings are drawn. This weighting is obtained by table look up in the context correlation table 508.

Context Significance Weighting (w_{sig}) One issue in predictions based on multiple contexts is the amount of trust (significance) on correlations between contexts. It may be common for the current context to have highly similar context neighbors that are based on very few numbers of co-rated services. The more data points available to compare, the more the correlation can be trusted as the true representative of the relation between two contexts. The accuracy of prediction can be further improved if those ratings that are based on too few samples are adjusted. The weights to predictions are adjusted according to a context significance weighting.

$${w}_{sig} = \{ \begin{matrix}\frac{M}{{M}_{threshold}} if M < {M}_{threshold} \\ 1\end{matrix} \qquad ( 4 )$$

M is the number of co-rated services between two contexts in the reduced dataset calculated in the first step of the algorithms, and M_{threshold} is an experimentally determined threshold. This weighting gives preference to correlations based on adequate sample size. Because the context significance weightings are computed from a context correlation table that is pre-computed, we can pre-compute the context significance weightings and store them in a context significance table. The algorithms simply look up the table at runtime.

At block 542, the context-based algorithms compute the prediction from k-nearest user neighborhood in m-closest contexts. One known formula given by has been shown to perform well in predicting ratings. This formula is modified with multiple contexts by incorporating the additional support weighting on each rating, and context similarity, context significance weightings on each context in m-closest context neighborhood. This is shown as follows.

$${P}_{a u , as , a c} = \frac{{\sum }_{u ∈ U , c ∈ C} {R}_{u , as , c} \cdot W}{{\sum }_{u ∈ U , c ∈ C} W} where W = {w}_{sin ( a u , u )} \cdot {w}_{sup ( u , as , c )} \cdot {w}_{sin ( ac , c )} \cdot {w}_{sig ( a c , c )} \qquad ( 5 )$$

P_{au,as,ac} is the prediction on a target service as for the active user au in the current context ac using ratings from its k-nearest user neighbors. W is a combined weighting from: (1) user similarity weighting w_{sim(au,u)} between the active user au and a user u who is in the user neighborhood; (2) support weighting w_{sup(u,as,c)} of the rating on the target service as for a user u in a context c, which is one of the m-closest contexts; (3) context similarity weighting w_{sim(ac,c)} between the current context ac and the context c; and (4) context significance weighting w_{sig(ac,c)} between the current context ac and the context c. This method computes a prediction by performing a weighted average from the user neighborhood, block 542.

Alternatively, context-based algorithms compute predictions from k-closest service neighborhood. As above, a reduced-size dataset of k-closest service neighbors in m-closest contexts is used, and the correlation between contexts is also considered. The solution can start with one original weighted sum formula and modify it with multiple contexts by incorporating the support weighting on each rating, context similarity weighting, and context significance weighting on each m-closest context. This is shown as follows.

$${P}_{a u , as , a c} = \frac{{\sum }_{s ∈ S , c ∈ C} {R}_{a u , s , c} \cdot W}{{\sum }_{s ∈ S , c ∈ C} W} where W = {w}_{sin ( a s , s )} \cdot {w}_{sup ( a u , a c )} \cdot {w}_{sin ( ac , c )} \cdot {w}_{sig ( a c , c )} \qquad ( 6 )$$

R_{au,as,ac} is the rating of the active user au on the target service as in the current context ac. W is a combined weighting from confidence weighting, service similarity weighting, context similarity weighting, and context significance weighting.

An alternative to context-based collaborative filtering algorithm is popularity-based recommendation. In popularity-based recommendation, the most popular overall services are recommended. Unlike collaborative filtering techniques that require complex computation, generating recommendations using a popularity-based technique is fast and efficient.

Popularity-based techniques may be applicable in some scenarios. For example, some smart environments may host a very limited number of user tasks, such that users in those environments will only ever choose a small set of services. Some businesses may have policies restricting the set of browser-based services users may use. Sometimes data may be so sparse that context-based collaborative filtering algorithms cannot form good user, context or service neighborhoods. Although a popularity-based algorithm does not have personalized analysis as collaborative filtering techniques do, however, we believe that it still generates appropriate recommendations in these scenarios.

The popularity-based algorithm works by simply computing the prediction for a weighted average rating on each service in the current context, and generating top-N recommendations with highest ratings. The normal approach to generate predictions is to compute the average rating on the service from all users' ratings on the given service, as shown in equation 7.

$${P}_{as} = \frac{{\sum }_{u ∈ U} {R}_{ u , a s}}{n} \qquad ( 7 )$$

Once the rating predictions are computed, the recommender uses a combination of the calculated prediction and the existing rating to derive a final rating on the target service for the active user in the current context, block 544. The reason is that if an existing rating has a low support, we would like to use a support weight adjusted rating for top-N service recommendation. The following relation of equation 8 can be used to derive the final prediction:

P_{final}=(1−wₛᵤₚ)·P+wₛᵤₚ·R (8)

P_{final} Is the final prediction. wₛᵤₚ is the support weight on the existing rating R (if rating is not empty), and P is the prediction computed above. The recommender then returns top-N service recommendation with the highest final predictions, block 546.

The following pseudocode for context-based collaborative filtering algorithm is presented as a procedure called RECOMMEND, which takes the active user and current context as the input parameters. The output of the procedure is an array of recommended services.

RECOMMEND (user, context, dataset)

```
  1 if collaborativeFiltering then
  2  Generate contextCorrelationTable from dataset offline;
  3  if userBasedApproach then
  4  for each service in dataset[user, context]
  5  Generate userCorrelationTable from dataset offline;
  6  Form  userNeighborhood for user from dataset using
          contextCorrelationTable and userCorrelationTable;
  7  Calculate prediction[service] for user in context using
          dataset, userNeighborhood and contextCorrelationTable;
  8  else if serviceBasedApproach then
  9  for each service in dataset[user, context]
10  Generate serviceCorrelationTable from dataset offline;
11  Form serviceNeighborhood for service from dataset using
          contextCorrelationTable and serviceCorrelationTable;
12  Calculate prediction[service] for user in context using
          dataset, serviceNeighborhood and contextCorrelationTable;
13 else if popularityBased then
14  for each service in dataset[user, context]
15  Calculate prediction[service] for user in context using
        dataset;
16 for each service in prediction
17  Adjust prediction[service] with existing rating from
      dataset[user, context, service];
18 Generate recommendation by sorting prediction and cutting off at
    n^{th} array index;
19 return recommendation;
```

From the foregoing, it can be seen that the present invention provides a new context-aware service recommendation system that pushes generic, relevant browser-based services by recommending them to a user on a mobile device based on current user context detected by smart environments. Compared to existing recommendation systems, the context-aware service recommender system disclosed herein uses context events as additional inputs to the system. The output includes lists of recommendation on relevant browser-based services instead of products or items of interest to the user as in traditional recommender systems.

While a particular embodiment of the present invention has been shown and described, modifications may be made. It is therefore intended in the appended claims to cover such changes and modifications which follow in the true spirit and scope of the invention.

We claim:

1. A context-aware service recommender system that recommends a list of services to a user on a mobile devices based on user context.

2. The system of claim 1 comprising:
at least one smart environment that provides current users' contexts;
a network-accessible recommender server that receives current user context from a remote recommendation agent, runs an algorithm to generate a list of recommended services, sends the list of recommended service back to the remote recommendation agent, receives feedback from the remote recommendation agent, and update a service relevance data set; and
a service recommender agent installable on a mobile device, the service recommender agent configured to relay current user context to the service recommender server, receive recommended services from the service recommendation server, display recommended services, monitor user's selection of services, and transmit user's service selection on services to the recommender server.

3. A service relevance rating dataset, where each entry in the matrix contains a rating that represents the level of relevance of a service to a user in a context.

4. The dataset of claim 3 wherein entries in the dataset can be empty, meaning that no user has been in a particular context, or no user has made service selection in a particular context.

5. The dataset of claim 3 wherein the dataset is updated using implicit feedback.

6. The dataset of claim 5 wherein the feedback is positive if the associated service is selected by the user.

7. The dataset of claim 5 wherein the feedback is negative if the associated service is recommended but not selected.

8. A method of service recommendation that uses context-mapping.

9. The method of claim 8 comprising.
calculating context similarity;
determining user or service neighborhood selections from multiple contexts; and
generating a list of recommended services based on user or service neighborhoods, active user, and current user context.

10. The method of claim 9 wherein calculating context similarity comprises computing a context correlation table.

11. The method of claim 9 wherein determining user neighborhood selections comprises computing a user correlation table.

12. The method of claim 9 wherein determining service neighborhood selections comprises computing a service correlation table.

13. A context-aware service recommendation system configured to push services to a user on a mobile device based on user context detected by a smart environment in which the mobile device operates.

14. The system of claim 13 comprising a recommender server configured to receive information about current user context from the mobile device and push the browser-based services in response to the received user context information.

15. The system of claim 14 further comprising a service recommender agent operating in conjunction with the mobile device.

16. The system of claim 15 wherein the recommender agent is further configured to detect services invoked by the user of the mobile device and relay information about invoked services as implicit feedback to the recommender server.

17. The system of claim 16 wherein the recommender agent is further configured to detect services not invoked by the user of the mobile device and relay information about uninvoked services with the implicit feedback to the recommender server.

18. The system of claim 14 wherein the recommender server is further configured to identify browser-based services relevant to the user based on the information about the current user context and return a list of recommended browser-based services.

19. The system of claim 18 wherein the recommender server is configured to identify the relevant browser-based services based on services the user has used before and services that may be relevant based on at least one of similar context, similar user and similar service.

20. The system of claim 19 wherein the recommender server is configured to establish service ratings based on at least one of similar context, similar user and similar service.

21. The system of claim 20 wherein the recommender server is configured to receive implicit feedback about invoked services from the mobile device and update the service ratings based on the implicit feedback.

22. A mobile device comprising:
a processing device;
a communication interface for communication with other devices; and
a recommender agent configured to receive user context data and communicate information about user contexts to a remote recommender server, and receive service recommendations developed based on the information about the context events.

23. The mobile device of claim 22 wherein the communication interface comprises a radio interface.

24. The mobile device of claim 22 wherein the mobile device is configured for internet communication for accessing browser-based services.

25. The mobile device of claim 22 wherein the recommender agent is further configured to send identity information and current user context to the recommender server.

26. The mobile device of claim 22 wherein the recommender agent is further configured to provide implicit feedback to the recommender server based on services invoked at the mobile device.

27. The mobile device of claim 22 further comprising:
a user interface configured to display information about the received service recommendations and to receive service selections.

28. The mobile device of claim 22 wherein the recommender agent is further configured to provide implicit feedback to the recommender server based on the received service selections.

29. The mobile device of claim 22 wherein the recommender agent comprises computer readable program code operable in conjunction with the processing device for controlling the mobile device.

30. The mobile device of claim 22 wherein the recommender agent is further configured to provide to the recommender server implicit feedback regarding selected services of the received service recommendations.

31. A service recommendation method, the method comprising:
receiving information about the current user context from a user mobile device;
computing a service recommendation list based at least in part on the received information about the current user context and a recommendation data set; and
communicating the service recommendation list to the user mobile device.

32. The service recommendation method of claim 31 further comprising:
receiving implicit feedback from the user mobile device;
updating the recommendation data set based on the implicit feedback.

33. The service recommendation method of claim 31 further comprising:
storing relevance rating in a service relevance dataset, where each entry in the matrix including a rating quantifying relevance of a service to a user in a context.

34. The service recommendation method of claim 31 further comprising:
receiving from the user mobile device feedback information about at least one of selected services and ignored services of the service recommendation list; and
deriving service relevance ratings based on the feedback information.

35. The service recommendation method of claim 34 further comprising:
classifying the feedback information;
updating ratings of the service relevance data set based on cumulative feedback.

36. The service recommendation method of claim 35 wherein classifying the feedback information comprises:
classifying the feedback information as positive if a user of the user mobile device selects a service from the service recommendation list; and
classifying the feedback information as negative if a service from the service recommendation list is ignored by the user of the user mobile device.

37. The service recommendation method of claim 31 wherein computing the service recommendation list comprises:
receiving a current user context and the service relevance data set;
determining recommended services based on services known to be of interest to similar users in similar contexts; and
filling the service recommendation list with the recommended services.

38. The service recommendation method of claim 37 wherein determining the recommended services comprises:
computing correlations between contexts using the service relevance data set to produce a context correlation table;
using an active user, an active user context, the service relevance data set and the context correlation table, forming at least one of a user neighborhood or a service neighborhood across multiple contexts, and at least one of a user correlation table or a service correlation table; and
using the at least one of a user neighborhood and a service neighborhood, the active user, the active user context, the context correlation table, and the at least one of a user correlation table and a service correlation table, producing a list of service recommendations.

39. The service recommendation method of claim 38 wherein computing the correlations comprises reducing data sparsity in the service relevance data set before computing the correlations.

40. The service recommendation method of claim 39 wherein reducing data sparsity comprises aggregating service categories.

41. The service recommendation method of claim 39 wherein reducing data sparsity comprises aggregating average user ratings.

42. The service recommendation method of claim 38 wherein forming the at least one of a user neighborhood or a service neighborhood across multiple contexts comprises:
computing at least one of user correlations or service correlations based on co-rated entries from all contexts and saving the result in one of the user correlation table or the service correlation table; and
selecting one of high-quality user neighbors or service neighbors.

43. A service relevance data set for use in recommendation services to one or more users, the relevance set comprising a three dimensional matrix <user, context, service>, each entry in the recommendation data set including a rating quantifying relevance of an indexed service to an indexed user in an indexed context.
